(19) United States
(12) Patent Application Publication
(10) Pub. No.: US 2023/0070411 A1
(43) Pub. Date: Mar. 9, 2023

(54) LOAD-BALANCER FOR CACHE AGENT

(71) Applicant: Intel Corporation, Santa Clara, CA (US)

(72) Inventors: Min LIU, Camas, WA (US); Xiang LI, Shanghai (CN); Shijie LIU, Shanghai (CN); Yannan SUN, Shanghai (CN); Lei ZHU, Shanghai (CN)

(21) Appl. No.: 17/987,382

(22) Filed: Nov. 15, 2022

(30) Foreign Application Priority Data
Oct. 24, 2022 (CN) PCT/CN2022/127039

(51) Int. Cl. G06F 3/06; G06F 12/0815

(52) U.S. Cl. CPC G06F 3/0613; G06F 12/0815; G06F 3/0653; G06F 3/0673

(57) ABSTRACT

Examples described herein relate to a central processing unit (CPU) that includes at least two cores, at least two caching agents (CAs), and circuitry to monitor a workload mapped to a CA of the at least two CAs and adjust the workload allocated to the CA to allocation among the CA and at least one other CA of the at least two CAs based on the monitored workload.

### RELATED APPLICATION

This application claims the benefit of priority to Patent Cooperation Treaty (PCT) Application No. PCT/CN2022/127039, filed Oct. 24, 2022. The entire contents of that application are incorporated by reference.

### BACKGROUND

In some examples, for particular addressable memory ranges accessible to particular central processing unit (CPU) sockets, a Home Agent (HA) can attempt to achieve data consistency among the memory devices and caches of CPU sockets connected to one or more memory devices. In some examples, an HA can be responsible for tracking state changes to one or more cache lines. A caching agent (CA) can attempt to determine whether another core or processor in a CPU socket has access to the same cache line and corresponding memory address to determine cache coherency. Where another core or processor has access to the same cache line and corresponding memory address, the CA can provide data from its cache slice or obtain a copy of data from another core's cache. The CA can forward a request for cache line data to one or more memory devices.

Some CPUs include consolidated Caching Agent (CA) and Home Agent (HA) functionality into a combined block called the CHA (Caching and Home Agent). A CHA can be responsible for a subset of memory and input/output (10) requests homed at its node. For example, FIG. 1 depicts an example of caching and home agent (CHA) topology that connects CHA, by mesh wiring, to memory controllers and other components such as cores, snoop filters (SF), last level caches (LLC), and Common Mesh Stop (CMS). CMS can connect a system agent to the mesh interconnection in the silicon package. When an agent (e.g., a microprocessor core) accesses memory or an I0 device, the agent can hash a request address to identify a destination CHA. The request can be routed through a mesh and arrive at the destination CHA for further address processing. Different agents can apply a same hash algorithm to identify a destination CHA, so completion of caching or home agent operations requests to access a specific physical address are routed to the same destination CHA.

### BRIEF DESCRIPTION OF THE DRAWINGS

FIG. 1 depicts an example of caching and home agent (CHA) topology.

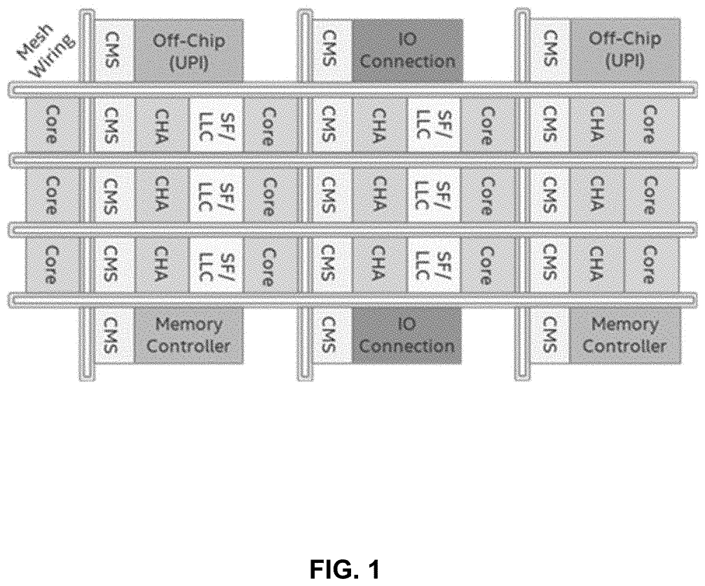

FIG. 2 illustrates a scenario in which memory intensive workloads and input output (10) intensive workloads executing on server platforms can overload one or more CHA.

FIG. 3 depicts an example of concurrent memory and 10 workloads processed by CHAs.

FIG. 4 depicts an example system.

FIG. 5 depicts use of a pre-reserved memory swap partition to re-allocate physical address ranges to one or more CHA.

FIG. 6 is an example of address range migration in connection with CHA load balancing.

FIG. 7 depicts an example CHA load-balancing process.

FIG. 8 depicts an example system.

FIG. 9 depicts an example system.

### DETAILED DESCRIPTION

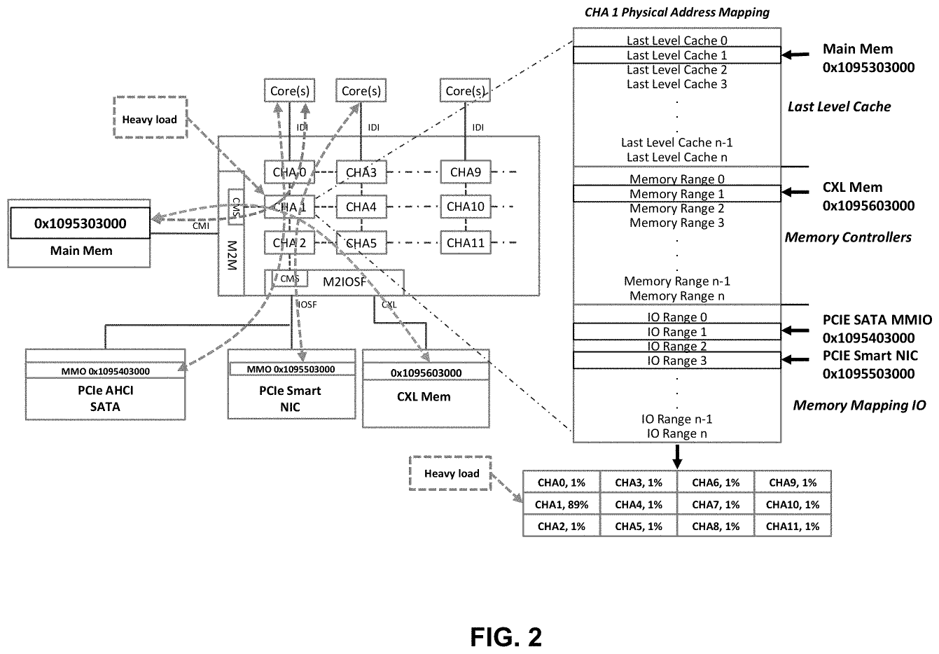

FIG. 2 illustrates a scenario in which memory intensive workloads and input output (IO) intensive workloads executing on server platforms can overload one or more CHA. When the same CHA resource is being requested continuously, the performance may degrade or sometimes the system malfunction in unexpected ways, which can negatively impact performance of workloads, potentially failing to meet service level agreement (SLA) parameters. In this example, due to unpredictable memory and 10 accesses in dynamic workloads, memory access can result in addresses assigned to a single CHA, such as CHA1. In turn, due to a heavy workload of CHA1, caching agent and/or home agent operations of CHA1 may be delayed to completion. For example, loads on CHA1 can arise from core memory managed input output (MMIO) read/write operations, core MMIO read/write operations, Compute Express Link (CXL) IO memory read/write operations, and core memory read/write stress.

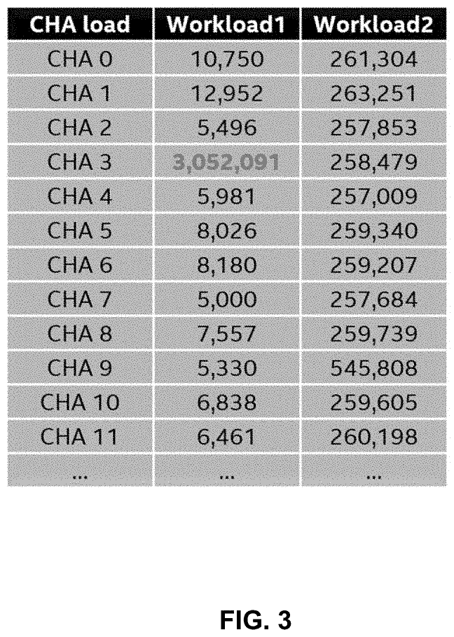

FIG. 3 depicts an example of concurrent memory and 10 workloads processed by CHAs. In this example, CHA3 has a workload that is multiples of workloads of other CHAs. Accordingly, time-to-completion of requests processed by CHA3 can increase and CHA3 can become a bottleneck.

At least to potentially reduce overloading one or more CHA, some examples monitor and dynamically balance load among CHAs at runtime to avoid hitting a performance bottleneck or other unexpected behavior due to the over stress to certain CHA. CHA load monitoring can be performed to centrally monitor CHA loads and identify one or more heavy-loaded CHA at runtime. A dedicated memory swap partition can be reserved in memory and address ranges can be reallocated among CHAs (including the heavily-loaded CHA) or to other lightly-loaded CHAs by moving data associated with memory addresses monitored by the heavily-loaded CHA to a pre-reserved memory swap partition.

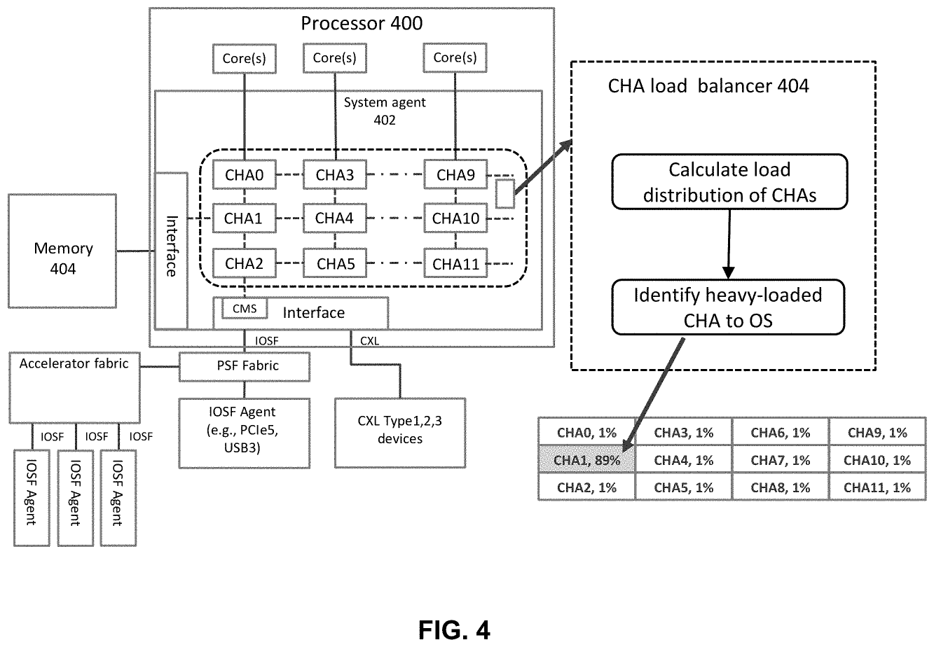

FIG. 4 depicts an example system. Processor 400 can include at least one or more cores and system agent 402. System agent 402 or uncore can include or more of a memory controller, a shared cache (e.g., last level cache (LLC)), a cache coherency manager, arithmetic logic units, floating point units, core or processor interconnects, Caching/Home Agent (CHA), interface circuitry (e.g., fabric, memory, device), and/or bus or link controllers. System agent 402 can provide one or more of: direct memory access (DMA) engine connection, non-cached coherent master connection, data cache coherency between cores and arbitrates cache requests, or Advanced Microcontroller Bus Architecture (AMBA) capabilities.

In some examples, one or more CHA among CHA0 to CHA11 or other circuitry in processor 400 can include load balancer circuitry 404 that is to determine monitoring and load balancing of workloads allocated to CHAs. For example, a hardware counter accessible to load balancer 404 can count input output (TO) or memory address transactions provided over a time duration to a CHA decoders of one or more of CHA0 to CHA11 in connection with memory or cache coherency or snoop requests. For example, a CHA decoder is to determine whether a cache coherency request or snoop request and associated memory addresses are handled by an associated CHA. Load balancer 404 can load distribution among CHAs such as by identifying a percentage of total load among the CHA0 to CHA11. Load balancer 404 can identify one or more heavily loaded CHA to an OS executed by a core and OS, or other software or hardware, can reserve a dedicated memory swap partition and then remap addresses that are identified as heavily loaded to one or more other CHAs by moving data having address ranges allocated to the heavily loaded CHA to the pre-reserved memory swap partition for re-allocation to one or more other CHAs to potentially achieve a more balanced CHA load distribution. A threshold for identifying a heavily-loaded CHA and the size of pre-reserved memory swap partition can be configured by a data center administrator and/or OS, in some examples.

Various manners of identify heavily loaded CHAs or memory address ranges are described herein. In this example, CHA1 is identified as having 89% of workloads performed over a time duration and is considered heavily loaded. Memory address ranges allocated to CHA1 can be allocated to other CHAs such as CHA0, CHA2, and so forth, so that the other CHAs can perform data and/or cache coherency and snoop filter workloads for those re-allocated memory address ranges.

Various examples of CHA data and/or cache coherency and snoop filter workloads are described next. Counters of CHA decoder activity or requests sent to CHA decoders can identify a number of performed workloads. CHA can attempt to achieve data coherency for particular addressable memory ranges so that a processor in a CPU socket receives a most up-to-date copy of content of a cache line that is to be modified by the processor. CHA can perform workloads that include tracking state changes to one or more cache lines and associated addressable memory ranges. CHA can perform workloads to determine cache coherency by monitoring cache line access by a core or processor and determining whether another core or processor has access to the same cache line and corresponding memory address. Where another core or processor has access to the same cache line and corresponding memory address, the CHA can provide data from its cache slice or obtain a copy of data from another core's cache. The CHA can forward a request for cache line data or a snoop request to one or more other CHA to perform the request. For example, a snoop request can include a determination of whether another device or process has altered data that is to be processed from a cache in order to obtain a current copy of the data. For example, if another CA manages a copy of content of the cache line in one or more of modified, exclusive, or forward states, a copy of content the cache line can be provided to the requester CHA.

For example, a CHA can notify another CHA if content of a cache line has been modified or a state of the cache line has been modified. For example, an indication that content of the cache line has been modified or a state of the cache line has been modified can include changing cache line state from invalid to shared or exclusive, from exclusive modified to shared or invalid mandatory, or from shared to exclusive mandatory. In response, a CHA can update a current state of the cache line based on the updated cache line state from another CHA to determine from which processor, core, or CPU socket to request cache line content modifications.

Examples described herein can apply to Intel® CPU architectures as well as processor architectures from Advanced Micro Devices, Inc. (AMD), NVIDIA, or others. Examples described herein can be utilized by various cache coherency protocols such as MESIF, MOESI, or others. Examples described herein can be utilized in various processor interconnect fabrics such as AMD Infinity Fabric™, AMD Core Complex (CCX), NVIDIA NVSwitch™, or others.

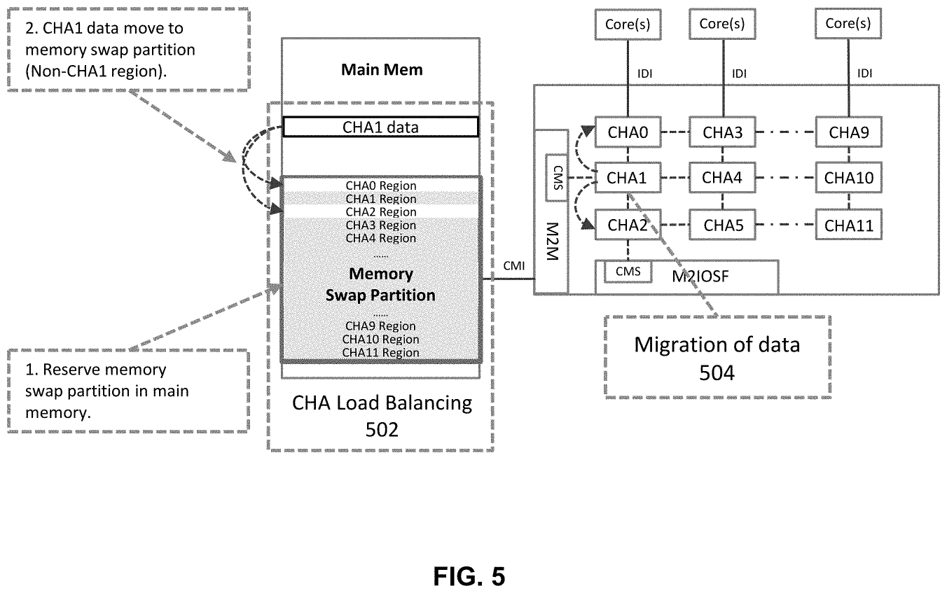

FIG. 5 depicts use of a pre-reserved memory swap partition to re-allocate physical address ranges to one or more CHA. At (1), an OS can reserve a dedicated memory swap partition in memory (e.g., main memory). At (2), the OS can remap memory address ranges considered heavily loaded to one or more other CHAs by copying data from memory allocated to the heavily loaded CHA to the pre-reserved memory swap partition to attempt to load balance CHA workloads. For example, a CHA can be identified as heavily allocated based on one or more of a number of addresses allocated to the CHA to manage data coherency and/or a number of transactions performed by the CHA meeting or exceeding a threshold level, as described herein. In this example, at 502 and 504, data associated with memory addresses identified as heavily loaded can be reallocated from CHA1 to CHA0 and CHA2 to perform load balancing.

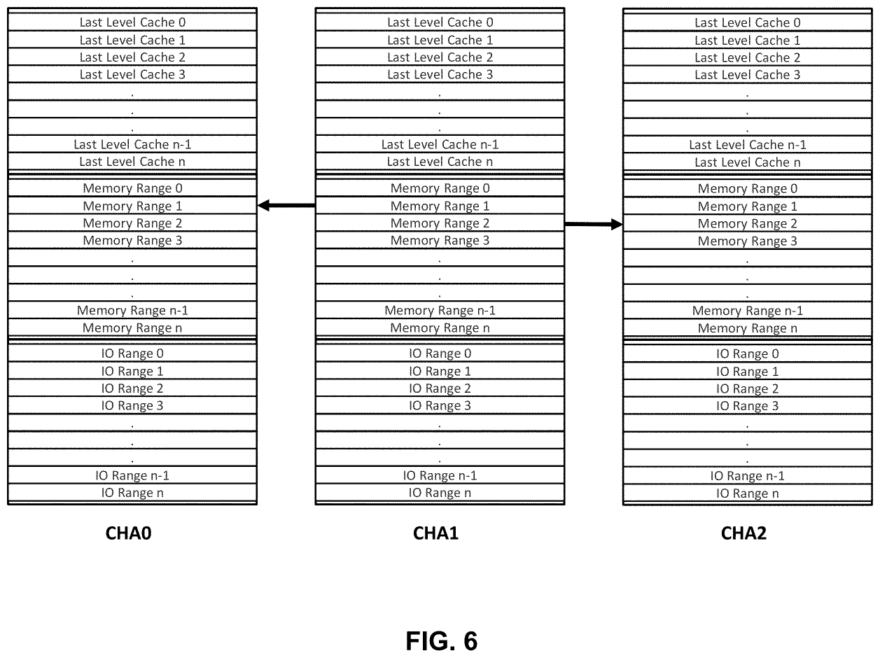

FIG. 6 is an example of address range migration in connection with CHA load balancing. Address ranges can be moved from memory mapped to CHA1 to mapped to less loaded CHA0 and CHA2 in a swap partition. For example, data mapped to a memory address range (Memory Range 1) managed by CHA1 can be re-allocated to memory address range (Memory Range 1) managed by CHA0. For example, data mapped to a memory address range (Memory Range 2) managed by CHA1 can be re-allocated to memory address range (Memory Range 2) managed by CHA2.

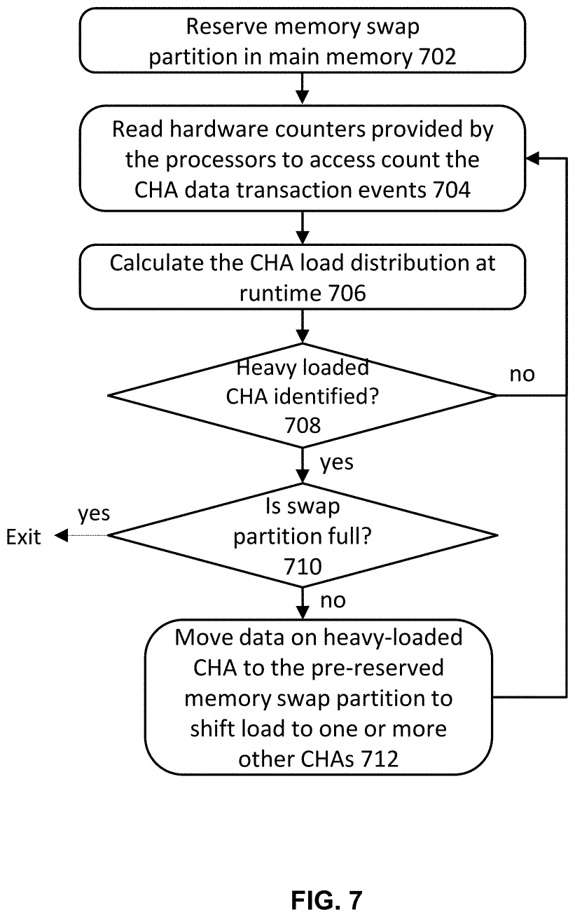

FIG. 7 depicts an example CHA load-balancing process. The process can be performed by a CHA, CA, or other circuitry or processor-executed instructions that manage data and/or cache coherency. At 702, a memory swap partition in one or more memory devices can be reserved for use to re-allocate a memory address range from a heavily loaded CHA to one or more other CHAs. At 704, a determination of data transactions to one or more CHAs can be performed. For example, hardware counters provided by the processors to access count the CHA data transaction events such as coherency requests, snoop requests, or other requests.

At 706, a load distribution can be calculated or determined for the one or more CHAs, at runtime. For example, a load of a CHA can be commensurate or based on a size of a memory address range allocated to the CHA to monitor and/or a number of CHA data transaction events over an amount of time that the CHA is to perform. Accordingly, loads of multiple CHAs can be determined.

At 708, a determination can be made if one or more heavily loaded CHAs are identified. For example, if a load on a CHA is at or more than a threshold difference than an average load of CHAs, then the CHA can be identified as heavily loaded. For example, if a load on one or more CHAs is at or more than a threshold, then the one or more CHAs can be identified as heavily loaded. For example, if a memory address range allocated to a CHA is at or more than a threshold difference than an average allocation of memory address ranges of CHAs, then the CHA can be identified as heavily loaded. For example, if a size of memory address range allocated to a CHA is at or above a threshold level, the CHA can be identified as heavily loaded. Based on one or more CHAs identified as heavily loaded, the process can proceed to 710. Based on no CHA identified as heavily loaded, the process can proceed to 704.

At 710, a determination can be made if the reserved swap partition is full. For example, a reserved swap partition can be identified as full based on no address being available for use. Based on the reserved swap partition being identified as full, the process can exit as re-allocation of loads among CHAs may not utilize a reserve swap partition. If a reserve swap partition is full, the service can escalate this situation to an OS and an administrator can decide actions to load balance workloads of CHA.

At 710, based on the reserved swap partition being identified as not full, the process can proceed to 712. At 712, the process can reallocate one or more memory address ranges allocated to the heavily loaded CHA to one or more other CHAs. For example, at least one memory address range from a heavily loaded CHA can be reallocated to one or more CHA with a relatively low level of allocated sizes of memory address ranges. For example, at least one memory address range from a heavily loaded CHA that is also identified as subject to a number of CHA data transaction events that meets or exceeds a threshold level can be reallocated to one or more CHA with a relatively low level of allocated sizes of memory address ranges.

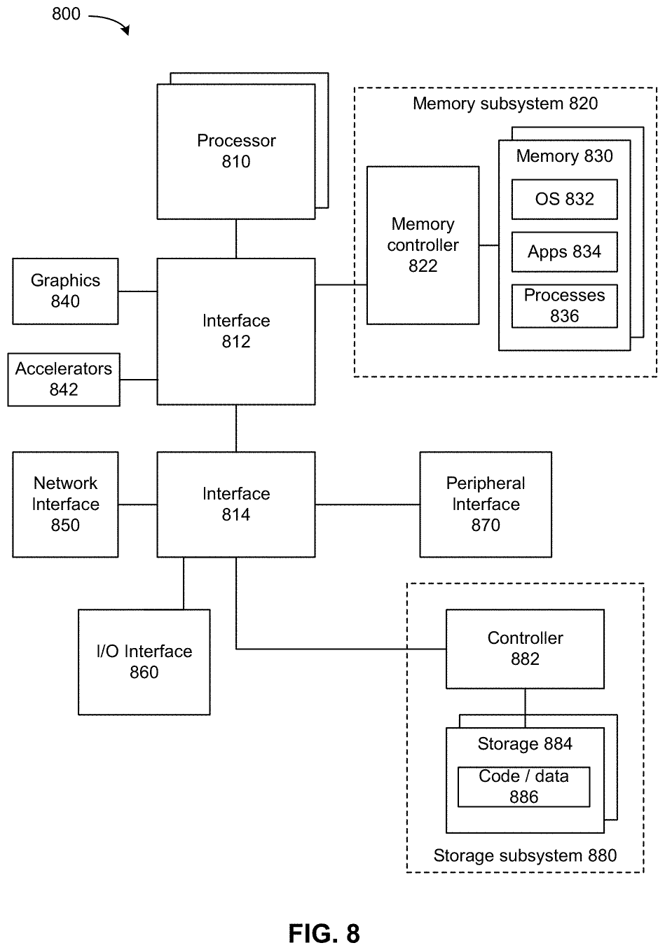

FIG. 8 depicts a system. In some examples, one or more CHA, CA, or HA of a CPU or other processor of processor 810 can monitor and load balance workloads, as described herein. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host. In some examples, an operating system can issue a configuration to a data plane of network interface 850.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others. In some examples, OS 832 or driver can configure one or more CHA to provide workloads allocated to one or more CHAs and to load balance memory address ranges among one or more particular CHAs, as described herein.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, network interface 850 or network interface device 850 can refer to one or more of: a network interface controller (NIC), a remote direct memory access (RDMA)-enabled NIC, SmartNIC, router, switch (e.g., top of rack (ToR) or end of row (EoR)), forwarding element, infrastructure processing unit (IPU), or data processing unit (DPU). An example IPU or DPU is described at least with respect to FIG. 12.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814. A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; chiplet-to-chiplet communications; circuit board-to-circuit board communications; and/or package-to-package communications. A die-to-die communications can utilize Embedded Multi-Die Interconnect Bridge (EMIB) or an interposer.

In an example, system 800 can be implemented using interconnected compute sleds of processors, memories, storages, network interfaces, and other components. High speed interconnects can be used such as PCIe, Ethernet, or optical interconnects (or a combination thereof).

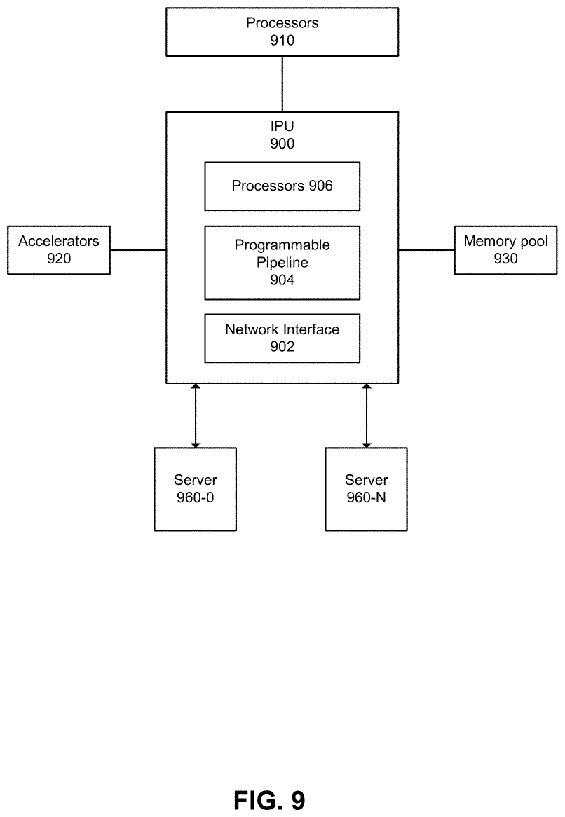

FIG. 9 depicts an example system. In this system, IPU 900 manages performance of one or more processes using one or more of processors 906, processors 910, accelerators 920, memory pool 930, or servers 940-0 to 940-N, where N is an integer of 1 or more. In some examples, processors 906 of IPU 900 can execute one or more processes, applications, VMs, containers, microservices, and so forth that request performance of workloads by one or more of: processors 910, accelerators 920, memory pool 930, and/or servers 940-0 to 940-N. IPU 900 can utilize network interface 902 or a switch (not shown) or one or more device interfaces to provide communication among processors 910, accelerators 920, memory pool 930, and/or servers 940-0 to 940-N. IPU 900 can utilize programmable pipeline 904 to process packets that are to be transmitted from network interface 902 or packets received from network interface 902.

Programmable pipeline 904 can include one or more packet processing pipeline that can be configured to perform match-action on received packets to identify packet processing rules and next hops using information stored in a ternary content-addressable memory (TCAM) tables or exact match tables in some embodiments. Programmable pipeline 904 can include one or more circuitries that perform match-action operations in a pipelined or serial manner that are configured based on a programmable pipeline language instruction set. Processors, FPGAs, other specialized processors, controllers, devices, and/or circuits can be used utilized for packet processing or packet modification. For example, match-action tables or circuitry can be used whereby a hash of a portion of a packet is used as an index to find an entry. Programmable pipeline 904 can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of programmable pipeline 904, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others.

In some examples, one or more CHA, CA, or HA of one or more processors of IPU 900 can monitor and load balance workloads, as described herein. In some examples, processors of IPU 900 can perform capabilities of a router, load balancer, firewall, TCP/reliable transport, service mesh, data-transformation, authentication, security infrastructure services, telemetry measurement, event logging, initiating and managing data flows, data placement, or job scheduling of resources on an XPU, storage, memory, or central processing unit (CPU).

In some examples, devices and software of IPU 900 can perform operations that include data parallelization tasks, platform and device management, distributed inter-node and intra-node telemetry, tracing, logging and monitoring, quality of service (QoS) enforcement, service mesh, data processing including serialization and deserialization, transformation including size and format conversion, range validation, access policy enforcement, or distributed inter-node and intra-node security.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a central processing unit (CPU) that includes: at least two cores; at least two caching agents (CAs); and circuitry to monitor a workload mapped to a CA of the at least two CAs and adjust the workload allocated to the CA to allocation among the CA and at least one other CA of the at least two CAs based on the monitored workload.

Example 2 includes one or more examples, wherein the workload comprises one or more of: processing of a cache coherency request or processing of a snoop filter request.

Example 3 includes one or more examples, wherein to monitor a workload allocated to a CA of the at least two CAs, the circuitry is to monitor a number of requests received at the at least two CAs over a time duration.

Example 4 includes one or more examples, wherein to monitor a workload allocated to a CA of the at least two CAs, the circuitry is to monitor a number of requests received at the at least two CAs for particular one or more memory address ranges over a time duration.

Example 5 includes one or more examples, wherein to monitor a workload allocated to a CA of the at least two CAs, the circuitry is to identify at least one CA of the at least two CAs to an operating system (OS) based on a load of the at least one CA of the at least two CAs.

Example 6 includes one or more examples, wherein to balance the workload allocated to the CA among the CA and at least one other CA of the at least two CAs, the circuitry is to allocate one or more memory addresses for monitoring by the CA and at least one other CA of the at least two CAs.

Example 7 includes one or more examples, wherein the allocate one or more memory addresses for monitoring by the CA and at least one other CA of the at least two CAs is based on a request from an operating system (OS).

Example 8 includes one or more examples, wherein the allocate one or more memory addresses for monitoring by the CA and at least one other CA of the at least two CAs comprises allocate data associated with the one or more memory addresses to a range of memory addresses.

Example 9 includes one or more examples, wherein the at least two CAs comprise at least one caching and home agent (CHA).

Example 10 includes one or more examples, and includes a server, wherein the server comprises the CPU and at least one memory device associated with one or more memory addresses associated with the at least two CAs.

Example 11 includes one or more examples, and includes a non-transitory computer-readable medium comprising instructions stored thereon, that if executed by one or more processors, cause the one or more processors to: execute an operating system (OS) that is to receive an indication of workloads of at least two caching agents (CAs) and to allocate workloads among the at least two CAs.

Example 12 includes one or more examples, wherein the workload comprises one or more of: processing of a cache coherency request or processing of a snoop filter request.

Example 13 includes one or more examples, wherein the indication of workloads comprise a number of requests received at the at least two CAs over a time duration.

Example 14 includes one or more examples, wherein the indication of workloads comprise a number of requests received at the at least two CAs for particular one or more memory address ranges over a time duration.

Example 15 includes one or more examples, wherein the allocate workloads among the at least two CAs comprises allocate one or more memory addresses for monitoring by the at least two CAs.

Example 16 includes one or more examples, wherein the at least two CAs comprise at least one caching and home agent (CHA).

Example 17 includes one or more examples, and includes a method that includes: at a central processing unit (CPU): monitoring a workload allocated to a caching agent (CA) of at least two CAs and allocating the workload allocated to the CA among the CA and at least one other CA of the at least two CAs.

Example 18 includes one or more examples, wherein the workload comprises one or more of: processing of a cache coherency request or processing of a snoop filter request.

Example 19 includes one or more examples, wherein the monitoring a workload allocated to a CA of the at least two CAs comprises monitoring a number of requests received at the at least two CAs over a time duration.

Example 20 includes one or more examples, wherein the allocating the workload allocated to the CA among the CA and at least one other CA of the at least two CAs comprises allocating one or more memory addresses for monitoring by the CA and at least one other CA of the at least two CAs.

What is claimed is:

1. An apparatus comprising:
a central processing unit (CPU) comprising:
at least two cores;
at least two caching agents (CAs); and
circuitry to monitor a workload mapped to a CA of the at least two CAs and adjust the workload allocated to the CA to allocation among the CA and at least one other CA of the at least two CAs based on the monitored workload.

2. The apparatus of claim 1, wherein the workload comprises one or more of: processing of a cache coherency request or processing of a snoop filter request.

3. The apparatus of claim 1, wherein to monitor a workload allocated to a CA of the at least two CAs, the circuitry is to monitor a number of requests received at the at least two CAs over a time duration.

4. The apparatus of claim 1, wherein to monitor a workload allocated to a CA of the at least two CAs, the circuitry is to monitor a number of requests received at the at least two CAs for particular one or more memory address ranges over a time duration.

5. The apparatus of claim 1, wherein to monitor a workload allocated to a CA of the at least two CAs, the circuitry is to identify at least one CA of the at least two CAs to an operating system (OS) based on a load of the at least one CA of the at least two CAs.

6. The apparatus of claim 1, wherein to balance the workload allocated to the CA among the CA and at least one other CA of the at least two CAs, the circuitry is to allocate one or more memory addresses for monitoring by the CA and at least one other CA of the at least two CAs.

7. The apparatus of claim 6, wherein the allocate one or more memory addresses for monitoring by the CA and at least one other CA of the at least two CAs is based on a request from an operating system (OS).

8. The apparatus of claim 6, wherein the allocate one or more memory addresses for monitoring by the CA and at least one other CA of the at least two CAs comprises allocate data associated with the one or more memory addresses to a range of memory addresses.

9. The apparatus of claim 1, wherein the at least two CAs comprise at least one caching and home agent (CHA).

10. The apparatus of claim 1, comprising a server, wherein the server comprises the CPU and at least one memory device associated with one or more memory addresses associated with the at least two CAs.

11. A non-transitory computer-readable medium comprising instructions stored thereon, that if executed by one or more processors, cause the one or more processors to:
execute an operating system (OS) that is to receive an indication of workloads of at least two caching agents (CAs) and to allocate workloads among the at least two CAs.

12. The non-transitory computer-readable medium of claim 11, wherein the workload comprises one or more of: processing of a cache coherency request or processing of a snoop filter request.

13. The non-transitory computer-readable medium of claim 11, wherein the indication of workloads comprise a number of requests received at the at least two CAs over a time duration.

14. The non-transitory computer-readable medium of claim 11, wherein the indication of workloads comprise a number of requests received at the at least two CAs for particular one or more memory address ranges over a time duration.

15. The non-transitory computer-readable medium of claim 11, wherein the allocate workloads among the at least two CAs comprises allocate one or more memory addresses for monitoring by the at least two CAs.

16. The non-transitory computer-readable medium of claim 11, wherein the at least two CAs comprise at least one caching and home agent (CHA).

17. A method comprising:
at a central processing unit (CPU):
monitoring a workload allocated to a caching agent (CA) of at least two CAs and allocating the workload allocated to the CA among the CA and at least one other CA of the at least two CAs.

18. The method of claim 17, wherein the workload comprises one or more of: processing of a cache coherency request or processing of a snoop filter request.

19. The method of claim 17, wherein the monitoring a workload allocated to a CA of the at least two CAs comprises monitoring a number of requests received at the at least two CAs over a time duration.

20. The method of claim 17, wherein the allocating the workload allocated to the CA among the CA and at least one other CA of the at least two CAs comprises allocating one or more memory addresses for monitoring by the CA and at least one other CA of the at least two CAs.
